(19) United States
(12) Patent Application Publication
(10) Pub. No.: US 2016/0299786 A1
(43) Pub. Date: Oct. 13, 2016

(54) CODE EXAMINATION BY SCHEDULER TIMELINE MANIPULATION

(71) Applicant: Microsoft Technology Licensing, LLC, Redmond, WA (US)

(72) Inventors: Bart De Smet, Bellevue, WA (US); Eric Rozell, Newcastle, WA (US)

(21) Appl. No.: 14/684,265

(22) Filed: Apr. 10, 2015

(51) Int. Cl. G06F 9/50

(52) U.S. Cl. CPC G06F 9/5038

(57) ABSTRACT

A scheduler timeline comprising a sequence of time stamped scheduling activities associated with scheduling execution of a computer program is exposed. The timeline can subsequently be modified in a variety of ways and utilized to schedule activities. For instance, activities can be added, removed, or reordered in a timeline. The timeline can be manipulated to enable code examination including testing and monitoring.

### BACKGROUND

Scheduling concerns mapping computational work to system resources for execution. The task of scheduling is one of selecting the next unit of work to be executed. The order in which work is executed is dictated by at least one scheduling policy. In one particular instance, scheduling can facilitate concurrent computing by ensuring correct sequences of interactions between different computational executions and coordinating access to resources. Computational work is scheduled for execution by a scheduler.

A scheduler is a component that provides three services. First, a scheduler controls when units of computational work, or activities, are executed. Second, a scheduler schedules execution of activities in a particular context such as a thread pool, a current thread, or another computer. Finally, a scheduler provides a notion of time.

An internal timeline is constructed by a scheduler that represents when activities will be scheduled for execution. When invoked, the scheduler causes activities to execute in a particular context as specified by the timeline and in accordance with the scheduler's notion of time.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to scheduler timeline manipulation. A timeline of scheduling activities generated by a scheduler internally can be exposed. The timeline can subsequently be manipulated in various ways to inject desired behavior for purposes of code examination. For instance, timeline activities can be added, removed, or reordered. Furthermore, virtual time dilation can be applied to expand time between activities to facilitate injecting new activities. In accordance with one aspect, a timeline can be manipulated to support code testing by simulating possible failure cases. In accordance with another aspect, the timeline can be manipulated to inject support for monitoring code execution.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a code examination system.

FIG. 2 is a block diagram of a scheduler supporting timeline manipulation.

FIG. 3 is a marble diagram illustrating instrumentation of a timeline with checkpoint, failure, and recovery.

FIG. 4 is a marble diagram depicting instrumentation of a timeline with full checkpoint, differential checkpoint, failure, and recovery.

FIG. 5 is a marble diagram showing optimized instrumentation of a timeline with checkpoint, failure, and recovery.

FIG. 6 is a marble diagram illustrating timeline manipulation for non-deterministic scheduling.

FIG. 7 is a flow chart diagram a method of code examination in conjunction with a scheduler timeline.

FIG. 8 is a flow chart diagram of a method of testing with a scheduler timeline.

FIG. 9 is a flow chart diagram of a method of addressing non-determinism in a timeline.

FIG. 10 is a schematic block diagram illustrating a suitable operating environment for aspects of the subject disclosure.

### DETAILED DESCRIPTION

Schedulers control the order in which activities or units of work are executed. More specifically, a scheduler generates a timeline of time stamped scheduling activities. Conventionally, however, this timeline is encapsulated within the scheduler and unreachable.

Query operators can manipulate event sequences. For example, a query operator can take an event sequence, perform some logic on the sequence, and output a notification or another event sequence. Further, multiple query operators can be chained together to obtain a desired result. Query operators can be logically layered on top of schedulers. More specifically, query operators can produce a series of tasks or activities that are scheduled for execution by a scheduler.

Examining query operators can be difficult. In a testing context, a plurality of tests has to be designed to simulate system failures at particular points while an event sequence is being processed. For example, test creators have to identify and determine how to reproduce a large number of potential failure scenario that impact query operators. Not only is this very time consuming, but also it is likely that the test creator will miss some edge cases.

Details below generally pertain to scheduler timeline manipulation. A timeline of a scheduler is exposed and available for inspection and manipulation. As a result, the timeline can be manipulated in various ways for purposes of code examination. In accordance with one aspect, transformations to the timeline can be made to simulate various testing scenarios. For example, fault tolerance of a query operator can be tested by adding checkpoints, failures, and recoveries to a timeline. Furthermore, virtual time dilation can be performed to expand a time interval between contiguous scheduled activities to facilitate addition of other activities. The timeline can also be inspected to determine whether schedule non-determinism exists, wherein activities occur at the same discrete time. A warning can be generated to notify a user of such non-determinism, and time dilation can be employed to enable testing with respect to timing combinations of activities. Manipulation is not limited to seeking to identify programming errors. The timeline can be manipulated for other reasons including monitoring execution associated with performance monitoring or profiling as well as accounting and quota management for compute cycles, among other things.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

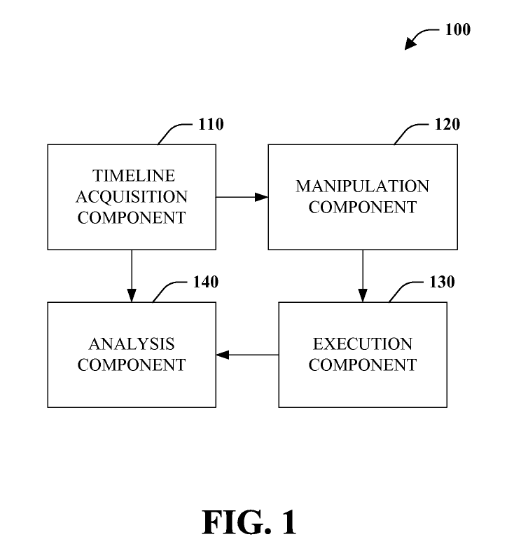

Referring initially to FIG. 1, code examination system 100 is illustrated. The code examination system 100 is a computer-implemented system that facilitates examination of a various aspects of programming code. The code examination system 100 includes timeline acquisition component 110, manipulation component 120, execution component 130, and analysis component 140.

The timeline acquisition component 110 is configured to receive, retrieve, or otherwise obtain or acquire a timeline of a scheduler associated with a particular computer program. A scheduler generates a timeline that comprises a sequence of time stamped scheduling activities associated with programming code. The timeline specifies the order in which activities will be scheduled for execution in some execution context. The activities are small atomic-level units of work utilized to implement high-level program code and can be mapped to threads of execution. Conventionally, timelines are encapsulated by the scheduler and not available outside the scheduler. In accordance with one embodiment, a program can be executed allowing the scheduler to schedule activities for execution. However, the scheduling process can be monitored such that the timeline can be reconstructed. In accordance with another embodiment, a scheduler can be modified to expose a scheduler timeline, or in other words make the timeline available for viewing and modification. Accordingly, the timeline acquisition component 110 can acquire the timeline from a monitoring process or from the scheduler itself

In accordance with one embodiment, the timeline acquired can be first class, or, in other words, a first-class citizen in a programming language. This means that the timeline is an entity that supports operations generally available to other entities, such as strings and integers, in the programming language. The operations include being passed as a parameter, returned from a function, and assigned to a variable. More specifically, a first-class timeline is able to be manipulated, for example by way of addition, deletion, and reorder, among other things.

The manipulation component 120 is configured to manipulate or enable manipulation of a timeline. Such manipulations can enable examination of programming code, for instance by way of testing or performance monitoring. In accordance with one embodiment, manipulation can enable fault tolerance testing. Checkpoint, failure, and recovery actions can be injected into the timeline, such that during execution the state of code is captured, a failure is simulated, and the state is subsequently recovered. A determination can be made as to whether or not a code is fault tolerant or fault tolerant enough (e.g., includes an acceptable delay).

The manipulation component 120 can also be employed to perform virtual time dilation, which can alter the time between scheduled activities in the timeline. For instance, time dilation can increase a timer interval between continuous activities, which can correspond conceptually to stretching out the timeline. Time dilation can enable injection of additional actions between other activities in the timeline, where otherwise no time was available.

Additionally, manipulation can correspond to instrumenting the timeline with monitoring activities that monitor execution. This monitoring can be employed to provide performance monitoring and profiling, among other things. In one instance, a score indicative of performance or health can be generated. Furthermore, activities can be reordered and/or removed. Generally, the timeline can be modified in a number of ways to simulate substantially any situation. By way of example, and not limitation, throttling, moving an operation to and from a dormant/sleep state, migrating to a new system, and updates to code can be simulated.

The execution component 130 is configured to initiate execution of a scheduler and scheduling of activities in accordance with a timeline. In one instance, this can be accomplished by initiating execution of the program. Execution can be performed with respect to a timeline automatically generated by the scheduler, a modified timeline, or both. In one instance, the automatically generated timeline can be directly manipulated. Alternatively, a modified timeline can be passed by value or reference to a scheduler for use in place of the automatically generated timeline.

The analysis component 140 is configured to receive, retrieve, or otherwise obtain or acquire results of programming code execution and perform some analysis based thereon. For instance, the analysis component 140 can acquire results of code executed in accordance with an unmodified schedule and results from code executed in accordance with a modified schedule injected with checkpoint, failure, and recovery operations and compare the results. If the results are the same the code can be identified as passing a fault tolerance test since checkpoint, failure, and recovery did not produce different results. By contrast, if the results are different the analysis component can indicate failure of the fault tolerance test, which may be the case if code does not store enough state to fully recover.

Where the timeline is instrumented with monitoring activities, the analysis component can analyze the data and produce a report or score associated with code execution. The analysis component 140 can also simply analyze the timeline itself to identify errors or other issues. In one instance, the analysis component 140 can detect non-determinism in a schedule, wherein different behavior can be exhibited on different runs despite the same input. Non-determinism can be detected by identifying activities that occur at the same discrete time. If non-determinism is determined, a notification can be generated and provided to a user warning of such non-determinism and potentially prompting modification of a computer program to remove the non-determinism.

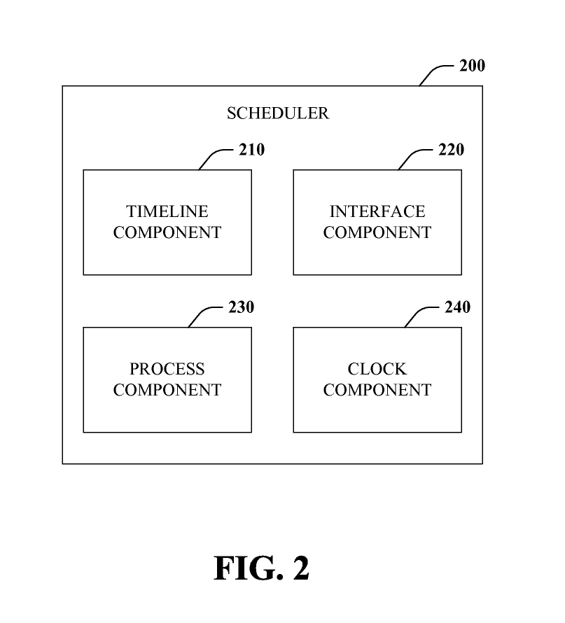

FIG. 2 depicts scheduler 200 (which can be a system or component as defined herein) configured to support timeline modification. The scheduler 200 includes timeline component 210, interface component 220, process component 230, and clock component 240. The timeline component 210 is configured to generate a timeline automatically comprising a sequence of time stamped scheduling activities. The timeline generated can be based a particular computer program as well as various policies, among other things.

The interface component 210 is configured to enable interaction with a generated timeline. In accordance with one aspect, the interface component 220 provides a mechanism to acquire the automatically generated timeline and well as return a modified timeline for use in scheduling activities. In this manner, the interface can be acquired, modified externally, for example by injecting, removing, or reordering activities, and returned. The interface component 220 can also be configured to enable timeline manipulation. For instance, the interface component 220 can provide a variety of operations that can be called to manipulate the timeline. By way of example, and not limitation, the interface component 220 can provide operations to inject activities, remove activities, reorder activities, and perform virtual time dilation to widen a time interval between activities. The interface component 220 can be utilized to modify the automatically generated timeline or generate a new modified timeline for use.

The process component 230 is configured to cause the scheduler 200 to perform scheduling when called or invoked. More specifically, the process component 230 can dispatch activities to execution context processing resources (e.g., thread, tread pool, remote computer . . . ) in accordance with a modified or unmodified timeline. Timeline activities are scheduled for execution based on a scheduler's notion of time.

Clock component 240 provides the notion of time. In accordance with one embodiment, the clock component supports virtual time, which does not correlated with to real world time or wall clock time used in daily life. Virtual time can start at any point and can advance at various rates as well as change speeds. For example, data that that spans years may be processed in a few seconds. This is useful for testing since it is desirable to have a test complete as soon as possible as opposed to waiting a year, for example, for processing that spans a year (e.g., event processing system). Clock component 240 is configured to monitor and manage virtual time. Activities can thus be scheduled for execution in virtual time as opposed to real time. Further, a scheduler that employs virtual time can also be referred to as virtual scheduler herein.

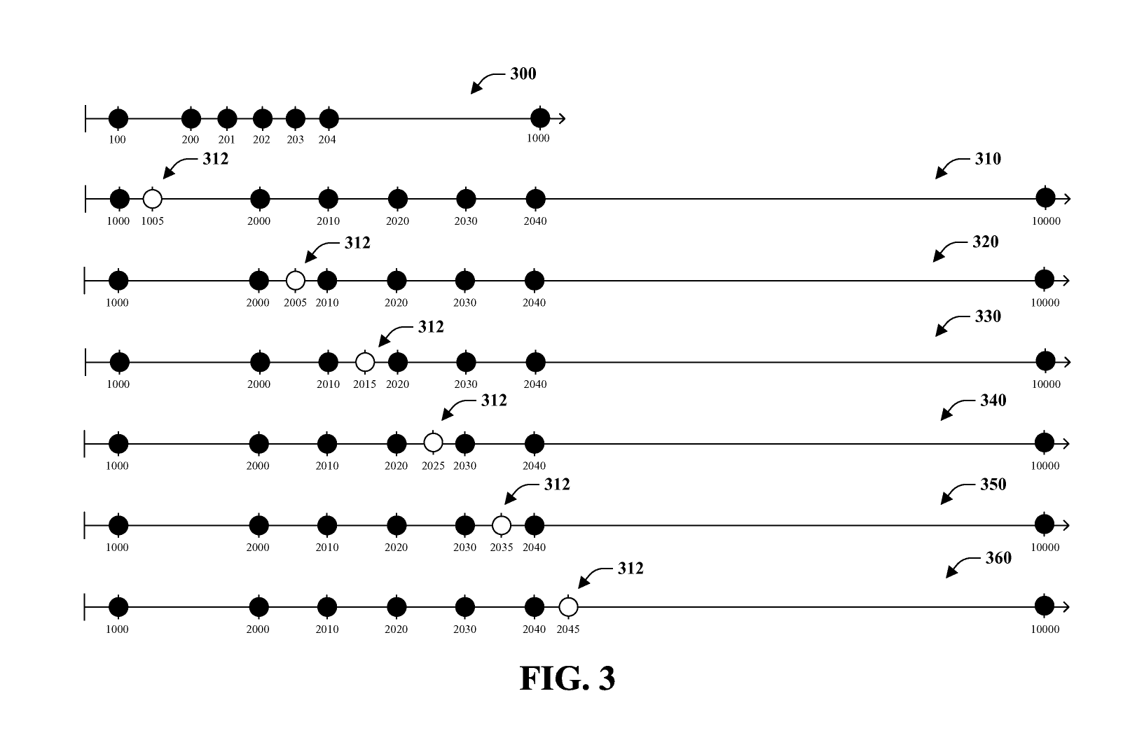

What follows are a number of marble diagrams in FIGS. 3-6 that illustrate examples of how a timeline can be manipulated to facilitate testing by way of simulating potential failure cases. Here, the testing corresponds to fault tolerance testing. Further, the testing may be described in terms of testing the fault tolerance of a query or query operator that operates over a data stream (e.g., sequence of push-based data) in an event-processing system. Of course, the description is intended solely to aid clarity and understanding various aspects of this disclosure and not to limit the aspects of this disclosure to testing, fault tolerance testing, or testing of query operators in an event processing system.

FIG. 3 illustrates timeline instrumentation with checkpoint, failure, and recovery. Timeline 300 depicts an initial, unmodified timeline automatically generated by a scheduler. Here, there are seven activities denoted by black dots and scheduled at times 100, 200, 201, 202, 203, 204, and 1000. For context, in an event processing system, the activities could correspond to invoking a subscription to a push-based asynchronous data source, pushing notifications to a subscriber, and terminating the subscription.

Timeline 310 illustrates a modified timeline including the same seven activities in timeline 300. Timeline 310, however, has been virtual time dilated. In particular, a time dilation factor of ten has been applied such that the scheduled time is multiplied by the time dilation factor (e.g. T1*10). Of course, the time dilation factor need not be ten but can be substantially any number. As a result, the activities scheduled at times 100, 200, 201, 202, 203, 204, and 1000 in timeline 300 are scheduled at times 1000 2000, 2010, 2020, 2030, 2040, and 10000 in timeline 310. Conceptually, the timeline has been stretched to allow a time interval for injecting additional activities.

In addition, timeline 310 has been instrumented with a checkpoint, failure, and recovery activity 312 denoted as a white dot at time 1005. In other words, at time 1005 a checkpoint is taken of code state, a failure is simulated where the code state is lost, and a recovery from the checkpoint is performed. For example, the code can correspond to event processing system query operator that yields the first five events in a sequence and skips the remainder of events in the sequence (e.g., Take[5]). The state of the query operator corresponds to the number of events taken so far or the number of events still needed. Here, the timeline is instrumented between activities at times 1000 and 2000. If execution of code with timeline 310 produces the same results as execution of code with timeline 300, it can be deemed to have passed the fault tolerance test. Otherwise, if the results produced by execution of the timelines 300 and 310 are different, the fault tolerance test can be said to have failed. In the case of failure, the source of potential error can be pinpointed between the time of the activity at time 1000 and the injected checkpoint, failure, recovery action at time 1005.

For comprehensive testing over all potential failure cases, checkpoint, failure, and recovery should be performed between all contiguous activities. Timelines 320, 330, 340, 350, and 360 depict the same time dilated timeline as timeline 310 but with the injected activity 312 between different contiguous activities. Timeline 320 shows the checkpoint, failure, recovery activity 312 performed at time 2005 between activities at times 2000 and 2010. Timeline 330 depicts the activity 312 at time 2015 between activities at times 2010 and 2020. Timeline 340 illustrates activity 312 at time 2025 between activities at times 2020 and 2030. Timeline 350 shows checkpoint, failure, recovery activity 312 at time 2035 between activities at time 2030 and 2040. Finally, timeline 360 depicts activity 312 at time 2045 between activities at time 2040 and 10000. By performing separate timelines for the interleaving of an injected activity between contiguous activities in the event of a test failure the source of the error better pinpointed. Overall, timelines 310, 320, 330, 340, 350, and 360 simulate all possible interleavings of a timeline activities and potential failure cases.

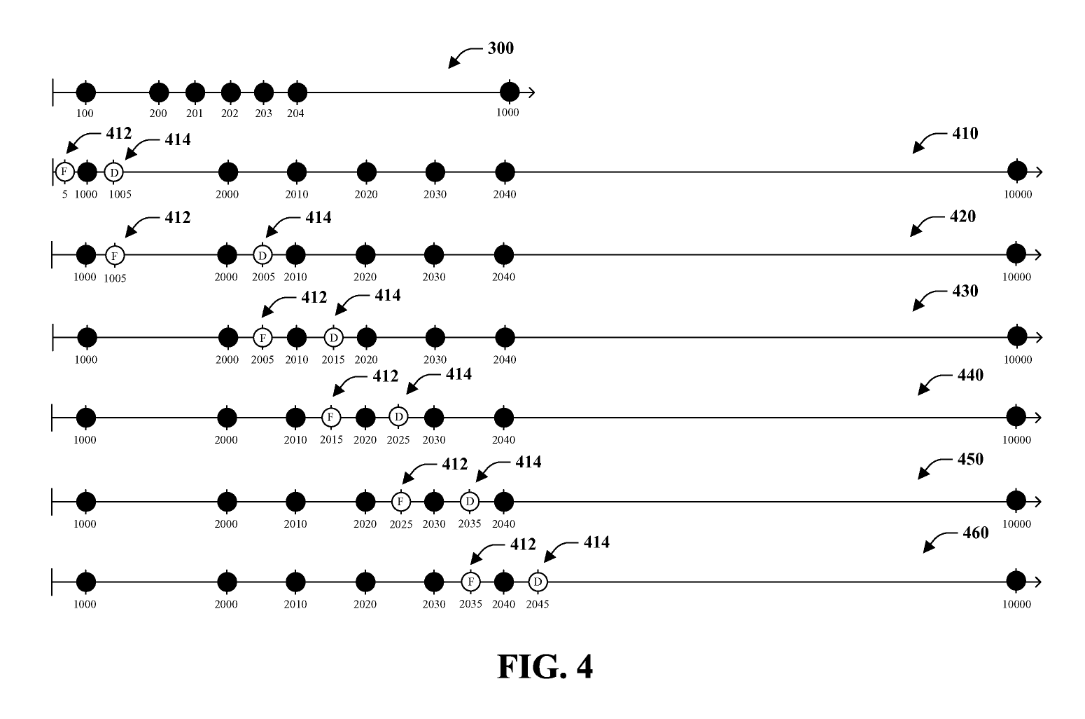

FIG. 4 depicts timeline instrumentation with checkpoint, failure, and recovery with full and differential checkpointing. Timeline 300 depicts an initial, unmodified timeline automatically generated by a scheduler. Here, there are seven activities denoted by black dots and scheduled at times 100, 200, 201, 202, 203, 204, and 1000.

Timeline 410 illustrates a modified timeline including the same seven activities in timeline 300. Timeline 410, however, has been time dilated. In particular, a time dilation factor of ten has been applied such that the scheduled time is multiplied by the time dilation factor (e.g. T1*10). Of course, substantially any time dilation factor can be chosen, but for this example, the factor is ten. As a result, the activities scheduled at times 100, 200, 201, 202, 203, 204, and 1000 in timeline 300 are scheduled at times 1000 2000, 2010, 2020, 2030, 2040, and 10000 in timeline 310. Conceptually, the timeline has been stretched to allow a time interval for injecting additional activities.

Timeline 410 has been instrumented with a checkpoint, failure, and recovery functionality. Here, however, there are two types of checkpoints, full and differential. A full checkpoint is something that takes the state of the entire system. A differential checkpoint takes state of only things that have changed since the last checkpoint. Timeline 410 has been instrumented with a full checkpoint activity 412 and a differential checkpoint, failure, recovery activity 414. More specifically, full checkpoint activity 412 has been injected at time 5 before the first activity at time 1000 and differential checkpoint, failure, recovery activity 414 has been added at time 1005 after the activity at time 1000. In the context of testing, if execution of code with timeline 410 produces the same results as execution of timeline 300, the fault tolerance test has passed. Otherwise, if the results are different, the fault tolerance test can be said to have failed.

Checkpoint, failure, and recovery should be performed between contiguous activities. Stated differently, the checkpoint, failure, and recovery together should be performed between each two adjacent activities in the timeline. With full and differential checkpoints, failure, and recovery, the full checkpoint activity 412 and the differential checkpoint, failure, recovery activity 414 should be inserted between each contiguous triple actions. In other words, between each contiguous set of three actions, a full checkpoint activity is inserted between the first and second actions and the differential checkpoint, failure, and recovery activity is inserted between the second and third activities. One exception is that a full checkpoint activity is inserted before the first activity and the differential checkpoint, failure, and recovery activity is inserted between the first activity and the second activity. Timelines 420, 430, 440, 450, and 460 depict the same time dilated timeline as timeline 410 but with the full checkpoint activity 412 and the differential checkpoint, failure, recovery activity 414 inserted between different contiguous triple actions. Timeline 420 shows activity 412 and activity 414 at times 1005 and 2005 between actions at times 1000, 2000, and 2010. Timeline 430 depicts full checkpoint activity 412 at time 2005 and differential checkpoint, failure, recovery activity 414 at time 2015 between activities 2000, 2010, and 2020. Timeline 440 illustrates action 412 and action 414 at times 2015 and 2025, respectively, between activities at times 2010, 2020, and 2030. Timeline 450 shows activity 412 at time 2025 and activity 414 at time 2035 between activities at times 2020, 2030, and 2040. Lastly, timeline 460 includes full recovery activity 412 at time 2035 and differential checkpoint, failure, recovery activity 414 at time 2045 between activities at times 2030, 2040, and 10000.

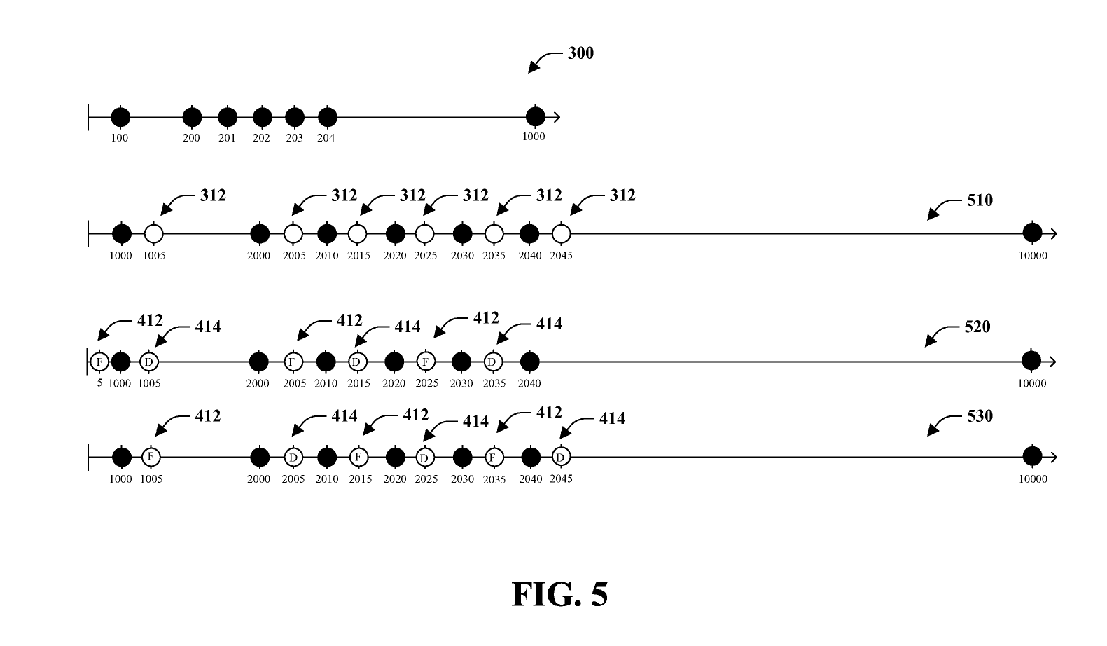

FIG. 5 depicts timeline instrumentation with checkpoint, failure, and recovery. As in FIGS. 3 and 4, timeline 300 depicts initial, unmodified timeline automatically generated by a scheduler. Seven activities denoted by black dots are included in the timeline 300 and scheduled at times 100, 200, 201, 202, 203, 204, and 1000. Timeline 510 includes checkpoint, failure, recovery activity 312 inserted between a distinct pairs of actions on in a single timeline time dilated by a factor of ten at times 1000, 2000, 2010, 2020, 2030, 2040, and 10000. In particular, activity 312 is inserted at times 1005, 2005, 2015, 2025, 2035, and 2045. This allows determining whether or not an error exists without being able to pinpoint the where one or more errors occur. Timelines 520 and 530 represent an optimization representing all scenarios for injecting full checkpoint activity 412 and differential checkpoint, failure, recovery activity 414 in two runs as opposed to six. Timeline 520 injects full checkpoint 412 at times 5, 2005, and 2025 and differential checkpoint, failure, recovery action 414 at times 1005, 2015, and 2035. Timeline 530 is instrumented with full checkpoint 412 at times 1005, 2015, and 2035 and differential checkpoint, failure, recovery action 414 at times 2005, 2025, and 2045. Similar to timeline 510, a determination can be made regarding whether or not an error exists with timeline 520 and timeline 530 without the ability to being able to isolate where one or more errors occur.

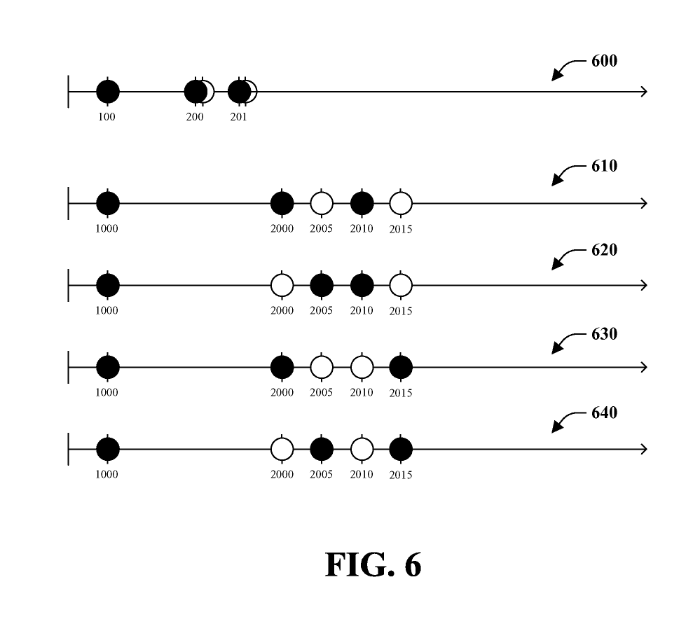

FIG. 6 illustrates timeline manipulation with respect to non-deterministic scheduling. Non-deterministic scheduling exists when two activities are scheduled at the same discrete time. Timeline 600 includes five events, one at time 100, two at time 200, and two at time 201. Two events scheduled at each of times 200 and 201 indicate non-determinism. To provide determinism, time dilation can be used and a series of timelines generated to represent all possible deterministic combinations. Timeline 610 illustrates timeline dilation by a factor of ten and injecting activities previously scheduled at the same time at different discrete times. In particular, activities are present to times 1000, 2000, 2005, 2010, and 2015. Timelines 620, 630, and 640 depict additional deterministic combinations of activities represented by black and white dots with respect to dilated times 200, 2005, 2010, and 2015.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, analysis component 140 can utilize such mechanism to infer errors with respect to timelines as well as results returned upon execution.

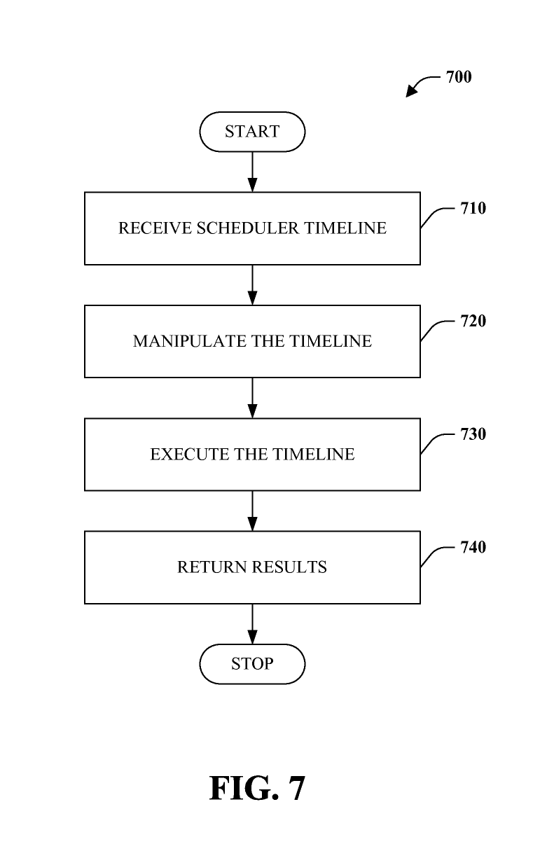

In view of the exemplary systems described above, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, is a method 700 of code examination in conjunction with a scheduler timeline is illustrated. At reference numeral 710, a scheduler timeline is received, retrieved, or otherwise obtained or acquired. The timeline comprises a time stamped sequence of scheduling activities associated with program code such as test code. The timeline can be acquired upon request from a scheduler or by monitoring scheduling by the scheduler, among other ways. At numeral 710, the timeline is manipulated to behave in a desired way. Here, manipulation can refer to directly modifying the received timeline or generating a new timeline that representation a modified timeline. In one embodiment, the timeline can be a first-class object. Accordingly, a variety of different programmatic techniques available for object generation and manipulation can be employed with respect to a timeline. In one particular implementation, the timeline can be represented as sequence of events, wherein event payloads include executable code or a data representation thereof A number of manipulations are possible including virtual time dilation and injecting, removing, and reordering activities, among other things. A variety of scenarios can be simulated for testing by way of timeline manipulation. For example, fault tolerance of code can be tested by injecting one or more actions associated with saving state, simulating a failure or loss of state, and recovering from the failure with the saved state. In another example, activities can be injected into the timeline to support monitoring the performance by capturing data at particular points during program execution. At reference numeral 730, timeline execution is at least initiated in conjunction with scheduling and program execution. At numeral 740, results are returned from execution of the timeline. If the behavior injected was associated with testing, the results can be compared with expected results to determine whether an error occurred or not. Alternatively, if the behavior corresponds to monitoring, the collected data can be returned and potentially further processed, for example to produce a health or performance score.

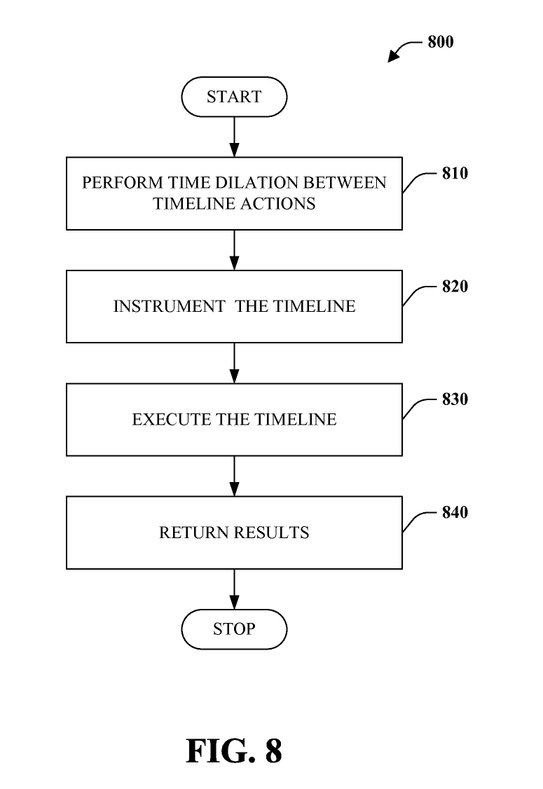

FIG. 8 depicts a method of testing 800 with a scheduler timeline. At reference numeral 810, time dilation is performed between activities of a scheduler timeline related to programming code such as test code. Time dilation can be used to expand time in conjunction with a virtual notion of time. This is useful to enable injection of activities between other activities. For example, consider a first activity scheduled at time 200 (T1) and a second action scheduled at time 201 (T2), such as timeline 310 in FIG. 3. If one desires to inject another activity between the first activity and the second activity, no time is available since the timeline has activities scheduled sequential at times 200 and 201. Time dilation can expand the time between the first and second activities by multiplying time by a factor. For instance, the first activity time of 200 (T1) and the second activity time of 201 (T2) can be multiplied by a factor of ten resulting in times 2000 (T1*10) and 2010 (T2*10), for example as shown in timeline 320 of FIG. 3. Now there is a time interval of nine units of time (e.g., ticks) between 2000 and 2010 available for additional actions. At reference 820, the timeline can be instrumented with custom behavior, for example by injecting, removing, and/or reordering activities. For example, an activity such as capturing state of a program or portion thereof can be injected within the dilated timeline between two activities such as the previously mentioned first activity and the second activity. At reference numeral 830, the execution of the modified timeline by a scheduler is initiated. For example, this can be accomplished by providing the scheduler with the modified timeline and initiating execution of programming code associated with the initial unmodified timeline, but this time with the modified timeline. At reference numeral 840, results can be returned and compared with expected results to determine whether an error is present or not.

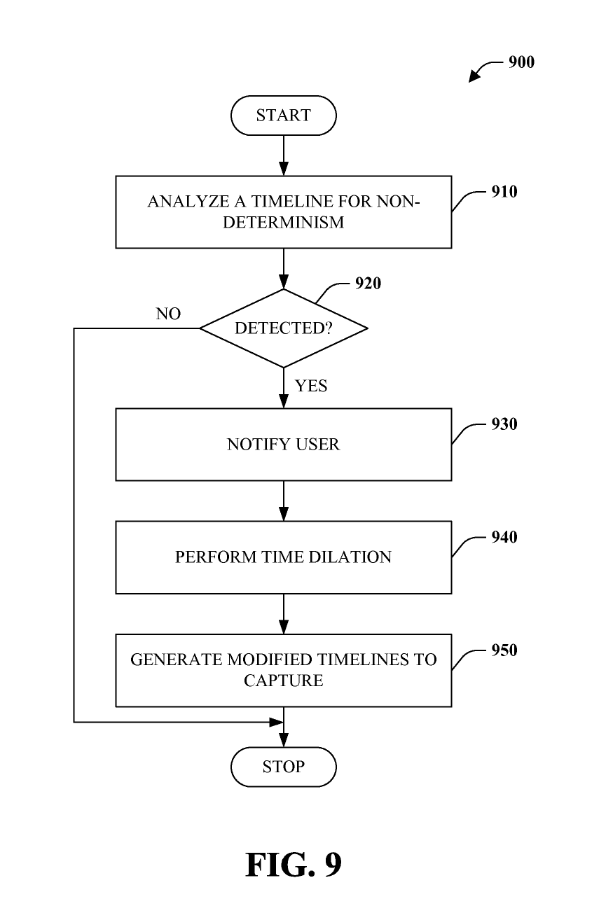

FIG. 9 illustrates a method 900 of addressing non-determinism in a scheduler timeline. At reference numeral 910, a scheduler timeline is analyzed for non-determinism. A timeline is non-deterministic if its behavior can differ across different runs of code. Non-determinism can be present in a timeline if more than one activity is scheduled the same time. At numeral 920, a determination is made as to whether or not non-determinism is detected. If non-determinism is not detected (“NO”), the method can terminate. If non-determinism is detected (“YES”), the method continues at 930 where a user can be notified of the non-determinism. Generally, non-determinism is undesirable. Accordingly, notification of non-determinism can prompt a user to re-writing test code in a deterministic way, if the non-determinism was unintended. However, there are some cases where non-determinism cannot be avoided, which can be addressed as follows. At numeral 940, virtual time dilation can be performed. Here, time is extended and provides a block of additional discrete time to allow scheduling at activities at different times. At 950, time dilated modified timelines are generated to capture different combinations of deterministic behavior that is possible. By way of example, if activity A and activity B are scheduled at the same time, two timelines are possible. A first timeline is generated where activity A is scheduled first and activity B is scheduled second in a time dilated timeline. A second timeline is generated to where activity B is scheduled first and activity A is scheduled second in a time dilated timeline. This enables accurate testing even in the presence of non-determinism.

Aspects of the subject application can be employed in the context of an event processing system. One particular implementation is Reactive Extensions, which is a library for composing event-based programs using observable sequences and declarative language integrated query (LINQ)-style query operators. Developers represent asynchronous data streams with observables that define a provider for push-based notification, query asynchronous data streams using declarative query operators integrated within a general purpose programming language that provide filtering, projection, aggregation, and sorting implemented as extension methods over observable types, and parameterize concurrency in the asynchronous data streams using schedulers. In accordance with one aspect, testing can be performed with respect to these or like query operators that sit inside query expressions.

More specifically, a determination may need to be made as to whether query operators that participate in a checkpointing mechanism for event-processing systems include all state required to recover computation over event sequences in a new environment. In other words, query operators are tested to determine whether they are fault tolerant. To have high confidence in the checkpointing mechanism and the state reported by query operators, a test creator would have to identify, enumerate, and determine how to reproduce a large number of scenarios where the state of the query operators would be affected. Not only is this extremely time consuming, but it is very likely that the test creator will miss some edge cases. As described herein, manipulations to scheduler timelines can be used to simulate multiple potential failure scenarios relative to a single test program.

The subject disclosure supports various products and processes that perform, or are configured to perform, various actions regarding scheduler timeline manipulation. What follows are one or more exemplary systems and methods.

A system comprises a processor coupled to a memory, the processor configured to execute the following computer-executable components stored in the memory: a first component configured to expose a first timeline comprising a sequence of time stamped scheduling activities associated with scheduling execution of a computer program; a second component configured to transform the first timeline to second timeline that varies from first timeline; and a third component configured to schedule activities in accordance with the second timeline. In one instance, the timeline includes a checkpoint activity that saves state associated with the computer program. In addition, the second timeline include failure and recovery activities. In another instance, the timeline includes an expanded time interval between at least two activities. In yet another instance, the timeline can include at least one performance monitoring activity. The system can also comprise a fourth component configured to provide a result of a comparison between an actual result and an expected result.

A method comprises employing at least one processor configured to execute computer-executable instructions stored in a memory to perform the following acts: receiving a timeline comprising a sequence of time stamped scheduling activities associated with scheduling execution of a computer program; modifying the timeline; and initiating scheduling with the modified timeline. In one instance, modifying the timeline comprises performing virtual time dilation between two contiguous activities to increase a time interval between the contiguous activities. Alternatively, modifying the timeline comprises adding a checkpoint activity as well as performing virtual time dilation to a time interval between two contiguous activities in the timeline and inserting the checkpoint activity between the two contiguous activities. Further, modifying the timeline comprises adding a recovery activity after the checkpoint activity and performing virtual time dilation to a time interval between two contiguous activities in the timeline and inserting the recovery activity between the two contiguous activities. Furthermore, modifying the timeline can comprise simulating failure between the checkpoint activity and the recovery activity. In yet another instance, modifying the timeline comprises inserting one or more activities to monitor performance. The method further comprises comparing output of scheduling with the modified timeline with expected output to determine if an error exists.

A computer-readable storage medium having instructions stored thereon that enable at least one processor to perform a method upon execution of the instructions, the method comprising: receiving a timeline comprising a sequence of time stamped scheduling activities associated with scheduling execution of a computer program; and checking for non-deterministic scheduling by determining whether the timeline includes one or more activities that are scheduled at the same time. The method further comprises generating a warning if one or more activities are scheduled at the same time. The method further comprises identifying deterministic combinations of one or more activities are scheduled at the same time. The method further comprises performing virtual time dilation to inject an interval of time between one or more activities scheduled at the same time as well as injecting checkpoint and recovery operations into the timeline.

Aspects of the subject disclosure pertain to the technical problem of examining software including testing and monitoring. The technical features associated with addressing this problem involve acquiring and manipulating a scheduler timeline, for example by adding, removing, and/or reordering activities. For instance, a timeline can be manipulated to support code testing by simulating possible failure cases or monitoring code execution. Accordingly, aspects of the disclosure exhibit technical effects with respect to producing reliable and efficient software programs.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

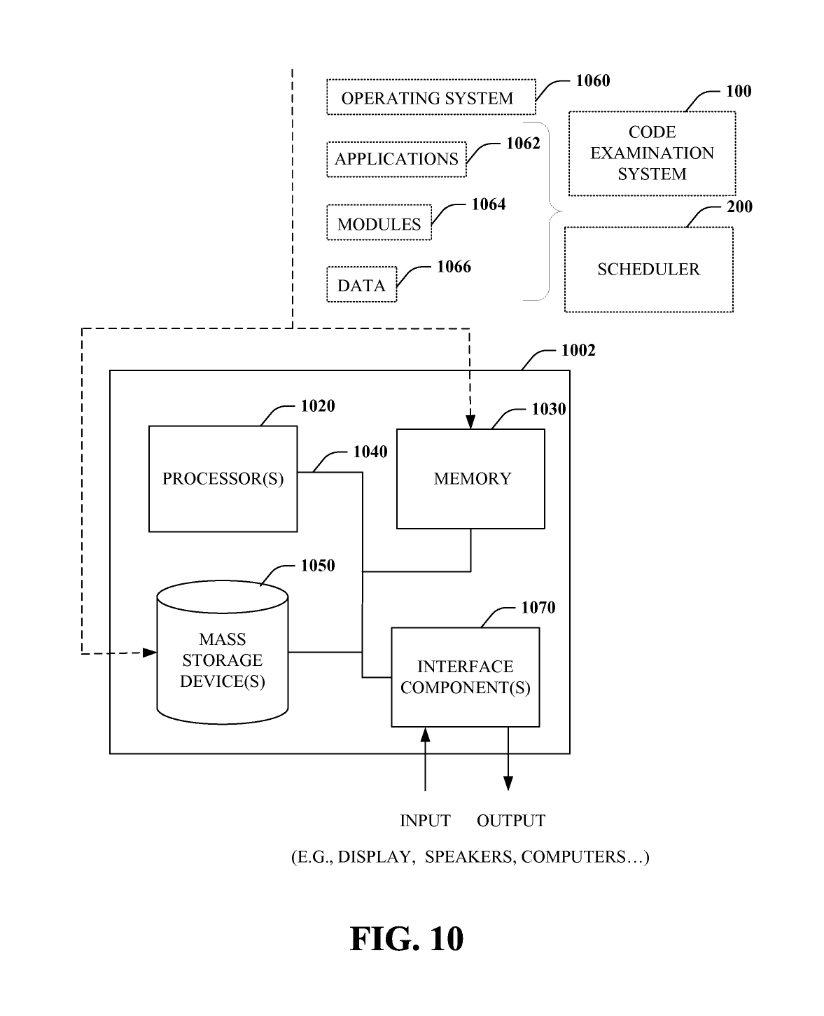

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory devices.

With reference to FIG. 10, illustrated is an example general-purpose computer or computing device 1002 (e.g., desktop, laptop, tablet, watch, server, hand-held, programmable consumer or industrial electronics, set-top box, game system, compute node . . . ). The computer 1002 includes one or more processor(s) 1020, memory 1030, system bus 1040, mass storage device(s) 1050, and one or more interface components 1070. The system bus 1040 communicatively couples at least the above system constituents. However, it is to be appreciated that in its simplest form the computer 1002 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) can be a graphics processor.

The computer 1002 can include or otherwise interact with a variety of computer-readable media to facilitate control of the computer 1002 to implement one or more aspects of the claimed subject matter. The computer-readable media can be any available media that can be accessed by the computer 1002 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 1002. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1030 and mass storage device(s) 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1002, such as during start-up, can be stored in nonvolatile memory, while volatile memory can act as external cache memory to facilitate processing by the processor(s) 1020, among other things.

Mass storage device(s) 1050 includes removable/non-removable, volatile/non-volatile computer storage media for storage of large amounts of data relative to the memory 1030. For example, mass storage device(s) 1050 includes, but is not limited to, one or more devices such as a magnetic or optical disk drive, floppy disk drive, flash memory, solid-state drive, or memory stick.

Memory 1030 and mass storage device(s) 1050 can include, or have stored therein, operating system 1060, one or more applications 1062, one or more program modules 1064, and data 1066. The operating system 1060 acts to control and allocate resources of the computer 1002. Applications 1062 include one or both of system and application software and can exploit management of resources by the operating system 1060 through program modules 1064 and data 1066 stored in memory 1030 and/or mass storage device (s) 1050 to perform one or more actions. Accordingly, applications 1062 can turn a general-purpose computer 1002 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, code examination system 100, scheduler 200, or portions thereof, can be, or form part, of an application 1062, and include one or more modules 1064 and data 1066 stored in memory and/or mass storage device(s) 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the code examination system 100, scheduler 200, and/or associated functionality can be embedded within hardware in a SOC architecture.

The computer 1002 also includes one or more interface components 1070 that are communicatively coupled to the system bus 1040 and facilitate interaction with the computer 1002. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1002, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., LCD, LED, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system comprising:
a processor coupled to a memory, the processor configured to execute the following computer-executable components stored in the memory:
a first component configured to expose a first timeline comprising a sequence of time stamped scheduling activities associated with scheduling execution of a computer program;
a second component configured to transform the first timeline to second timeline that varies from first timeline; and
a third component configured to schedule execution of activities in accordance with the second timeline.

2. The system of claim 1, the second timeline includes a checkpoint activity that saves state associated with the computer program.

3. The system of claim 2, the second timeline includes failure and recovery activities.

4. The system of claim 3 further comprises a fourth component configured to provide a result of a comparison between an actual result and an expected result.

5. The system of claim 1, the second timeline includes an expanded time interval between at least two of the activities.

6. The system of claim 1, the second timeline includes at least one performance monitoring activity.

7. A method comprising:
employing at least one processor configured to execute computer-executable instructions stored in a memory to perform the following acts:
receiving a timeline comprising a sequence of time stamped scheduling activities associated with scheduling execution of a computer program;
modifying the timeline; and
initiating scheduling with the modified timeline.

8. The method of claim 7, modifying the timeline comprises performing virtual time dilation between two contiguous activities to increase a time interval between the contiguous activities.

9. The method of claim 7, modifying the timeline comprises adding a checkpoint activity.

10. The method of claim 9 further comprises performing virtual time dilation to a time interval between two contiguous activities in the timeline and inserting the checkpoint activity between the two contiguous activities.

11. The method of claim 9, modifying the timeline comprises adding a recovery activity after the checkpoint activity.

12. The method of claim 11 further comprises performing virtual time dilation to a time interval between two contiguous activities in the timeline and inserting the recovery activity between the two contiguous activities.

13. The method of claim 11, modifying the timeline comprises simulating failure between the checkpoint activity and the recovery activity.

14. The method of claim 7 further comprises comparing output of scheduling with the modified timeline with expected output to determine if an error exists.

15. The method of claim 7, modifying the timeline comprises inserting one or more activities to monitor performance.

16. A computer-readable storage medium having instructions stored thereon that enable at least one processor to perform a method upon execution of the instructions, the method comprising:
receiving a timeline comprising a sequence of time stamped scheduling activities associated with scheduling execution of a computer program; and
checking for non-deterministic scheduling by determining whether the timeline includes one or more activities that are scheduled at the same time.

17. The computer-readable storage medium of claim 16, the method further comprises generating a warning if one or more activities are scheduled at the same time.

18. The computer-readable storage medium of claim 16, the method further comprises identifying deterministic combinations of one or more activities are scheduled at the same time.

19. The computer-readable storage medium of claim 16, the method further comprises performing virtual time dilation to inject an interval of time between one or more activities scheduled at the same time.

20. The computer-readable storage medium of claim 16, the method further comprises injecting checkpoint and recovery operations into the timeline.
